(19) United States
(12) Patent Application Publication
(10) Pub. No.: US 2013/0233179 A1
(43) Pub. Date: Sep. 12, 2013

(54) BREWING STRUCTURE FEATURING STABILITY AND WATER CONFINEMENT

(71) Applicants: PAO-WU TIEN, Taipei City (TW); Yu-Mei Tien Lin, Taipei City (TW)

(72) Inventors: PAO-WU TIEN, Taipei City (TW); Yu-Mei Tien Lin, Taipei City (TW)

(21) Appl. No.: 13/414,716

(22) Filed: Mar. 8, 2012

(51) Int. Cl. A47J 31/46

(52) U.S. Cl. 99/323

(57) ABSTRACT

A brewing structure featuring stability and water confinement is provided, including a support frame, a container, a filter, and a movable assembly. The support frame has a retention device. The container has a positioning section and a fitting section. The positioning section and the fitting section are retained on the retention device so that a brewing operation can be carried out in a stable manner at a predetermined altitude. The container forms a bore and a guide section is formed around the bore and extends downward. The movable assembly controls water discharging through the bore or blocks the bore. The movable assembly includes a body forming a water collection hole. A joint section and a water collection section are formed around a circumference of the water collection hole.

### (a) TECHNICAL FIELD OF THE INVENTION

The present invention generally relates to a brewing structure that features stability and water confinement so as to allow a container to be stably positioned at a predetermined altitude to safely carry out a brewing operation ad preventing outward splashing in dispensing liquid.

### (b) DESCRIPTION OF THE PRIOR ART

Referring to FIG. 8, a conventional brewing kettle is shown. The brewing kettle comprises a container 90 that forms a bore 901, a water stop 91 received in the container 90, a filter 92, and a mounting tray 93 formed on the bottom of the container 90 and vertically movable. When a brew substance has been brewed in the container 90 for a predetermined period of time, the container 90 is positioned on a cup 94, whereby the cup 94 may push the mounting tray 93 upward to have a stem 931 pushes the water stop 91 away from the bore 901, allowing the brewed liquid inside the container 90 to flow through the bore 901 and subsequently pass openings 932 of the mounting tray 93 to be dispensed into the cup 94.

The conventional brewing device shows the following disadvantages:

(1) The container 90 is positioned on the cup 94 by a substantial height, so that it is easy that the container 90 tilts and falls down, making high temperature brewing liquid splashing everywhere and hurting a person standing by the container.

(2) The brewing liquid, after flowing through the bore 901, may impact retention ribs 933 located between the openings 932, the stem 931, and an upper surface of the mounting tray. The brewing liquid may spread between the lower end of the container and the upper surface of the mounting tray 93. Generally, no shielding, water concentration, and water guidance measure is provided so that the brewed liquid, after flowing through the bore 901, may easily spread, diffuse, collide, penetrate, and thus splash and spread outward, causing undesired falling onto tabletop.

(3) After the liquid has been dispensed, the container 90 is often placed on a tabletop. Due to residue of the liquid remaining on the mounting tray 93, the tabletop may be stained.

### SUMMARY OF THE INVENTION

The object of the present invention is to provide a brewing structure featuring stability and water confinement.

To achieve the above object, the present invention provides a brewing structure that comprises a support frame, a container, a filter, and a movable assembly. The support frame comprises a retention device. The container comprises a positioning section and a fitting section, so that with the positioning section and the fitting section being retained on the retention device, a brewing operation can be carried out in a stable manner at a predetermined altitude. Further, the container forms a bore and a guide section is formed around the bore and extends downward. The movable assembly controls water discharging through the bore or blocks the bore. The movable assembly comprises a body forming a water collection hole. A joint section and a water collection section are formed around a circumference of the water collection hole. When a brewed liquid is discharged through the bore, the guide section, the joint section, and the water collection section collectively provide an effect of multi-layered shielding, water collection, and flow guidance so as to prevent the brewed liquid from undesirably leakage, splashing, and spreading.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is an exploded view of the present invention.

FIG. 2A is a cross-sectional view, in an enlarged scale, of a portion of the present invention.

FIG. 3 is a cross-sectional view showing the present invention in a water-stopped condition.

FIG. 4 is another cross-sectional view showing the present invention in a water-stopped condition.

FIG. 4A is a cross-sectional view, in an enlarged scale, of a portion of the present invention.

FIG. 5 is a cross-sectional view showing the present invention in a water discharging condition.

FIG. 5A is a cross-sectional view, in an enlarged scale, of a portion of the present invention.

FIG. 6 is a cross-sectional view showing the present invention in a condition after water is drained.

FIG. 7 is a perspective view showing a lid according to the present invention providing an effect of flow guidance.

FIG. 7A is a cross-sectional view, in an enlarged scale, of a portion of the present invention.

FIG. 8 is a cross-sectional view showing a conventional brewing device.

FIGS. 8A and 8B are respectively a cross-sectional view and a perspective view, both in enlarged scales, showing portions of the conventional brewing device.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

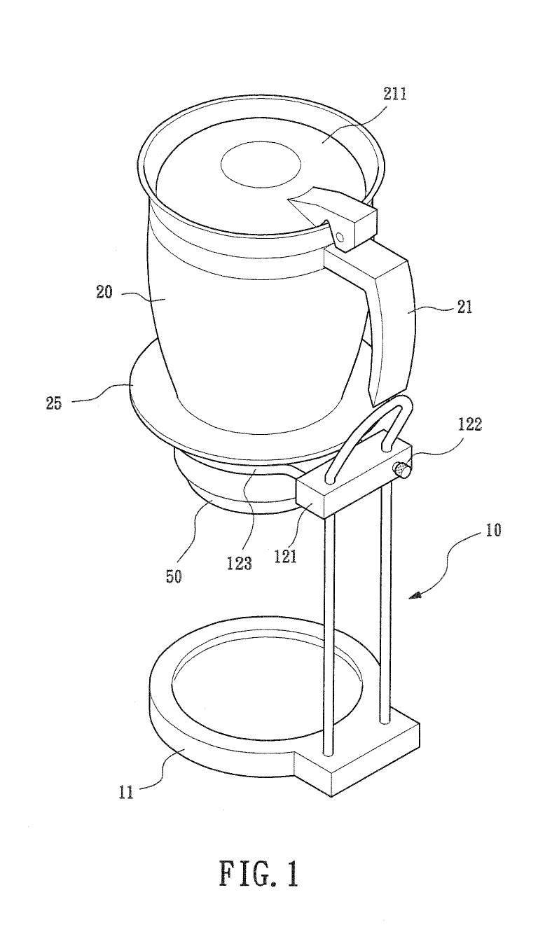

Referring to FIGS. 1, 2, and 3, the present invention comprises a support frame 10, a container 20, an elastic member 30, a filter 40, a movable assembly 50, and a valve 60.

The support frame 10 forms at a lower end a platform 11 for the purposes of stably positioning. The support frame 10 forms at an upper end an inverted U-shape that diverges outward for easy hand holding. The support frame 10 forms a retention device 12, and the retention device 12 is vertically movable through a movable seat 121 slidably mounted to the support frame 10. The movable seat 121 comprises a locking member 122, such as a screw, extending therethrough to be selectively set in tight engagement with the support frame 10. The movable seat 121 comprises a frame 123 mounted to a side thereof to form an opening 124.

The container 20 comprises a handle 21 mounted to a side wall thereof for hand holding. The handle 21 receives a lid 211 pivotally connected to a top end thereof for selectively closing an opening of the container 20. The container 20 has a bottom forming a bore 22 through which brewed liquid can flow. The bore 22 receives the elastic member 30 therein to engage therewith. The elastic member 30 is made of food-grade silicon rubber and forming an opening 31. When the valve 60 is caused by the movable assembly 50 to move downward and thus block the opening 31, sealing is established therebetween. The container 20 forms on an inside surface thereof a plurality of projections 23 for engaging and thus retaining the filter 40. The container 20 forms in the bottom thereof a plurality of mounting pegs 24 that extends downward for positioning the movable assembly 50. Each of the mounting pegs 24 has a diameter-expanded distal end 241 and forms at least one elastically deformable slot 242 to make the mounting peg 24 elastically deformable. The container 20 forms on a circumferential side wall thereof a horizontal disk like positioning section 25 having an outside diameter greater than that of the opening 124. The container 20 also forms on the bottom thereof a fitting section 26 that has an outside diameter smaller than the opening 124. The fitting section 26 may receive an upper portion of the movable assembly 50 thereof for protecting the movable assembly 50.

The filter 40 has a circumferential wall that is set in tight engagement with an inner circumferential surface of the container 20 and an upper edge of the circumferential wall of the filter 40 engages and is thus retained by the projections 23 in position in such a way that removal is easy for cleaning the foreign substance contained in the brewed liquid. The filter 40 comprises a grip section 41 through which a through aperture is formed.

The movable assembly 50 comprises a body 51 and the body 51 forms a plurality of through holes 52 respectively corresponding to the mounting pegs 24. The through holes 52 has an inside diameter that is greater than an outside diameter of the mounting pegs 24 but smaller than that of the distal ends 241, whereby when the container 20 is coupled to the movable assembly 50, the distal ends 241 of the mounting pegs 24 undergoes elastic deformation for penetration through the through holes 52, and after than, the distal ends 241 are expanded to engage and be thus each retained by a circumferential portion of a wall of the movable assembly 50 around each of the through holes 52. The mounting pegs 24 are received in the through holes 52 in a movable manner so that the movable assembly 50 can be readily coupled beneath the container 20 without undesired separation and the movable assembly 50 is allowed to move up and down in a stable manner with liquid is dispensed from the container 20 or is blocked. The body 51 further forms a water collection hole 53, in which ribs 54 are mounted in such a way to allow liquid to flow therethrough. Mounted on the ribs 54 is a valve stem 55 that is received in the opening 31 of the elastic member 30 (and the bore 22). The valve stem 55 has a distal end coupled to the valve 60 that removably blocks the opening 31, whereby when the valve stem 55 is moved upward, the valve 60 is push away from the position where it engages the opening 31 so as to release the blocked condition of the opening 31 (and thus the bore 22).

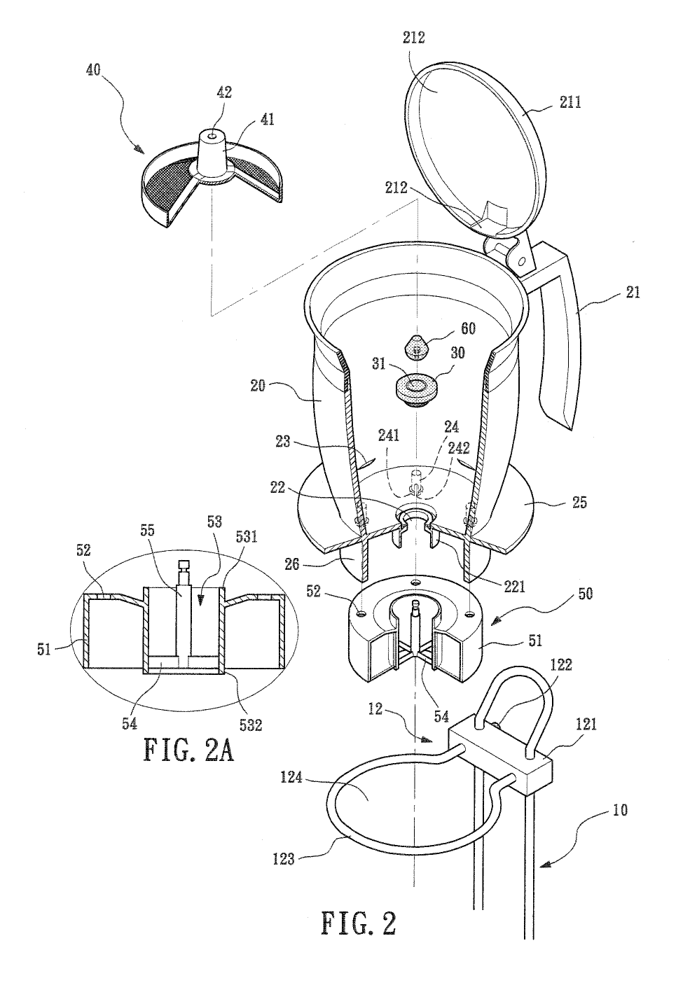

Referring to FIGS. 2 and 4, according to the present invention, a guide section 221, which is in a tubular form, projects down under the bore 22. The water collection hole 53 has a circumferential wall forming a joint section 531, in a tubular form projecting upward beyond the body 51 of the movable assembly 50 to fit to and joint with the guide section 221 and a water collection section 532, also in a tubular form, extending down beyond a lower side of the body 51, whereby a water guide channel that features a multi-layered shielding, water collection, and flow guidance structure is formed.

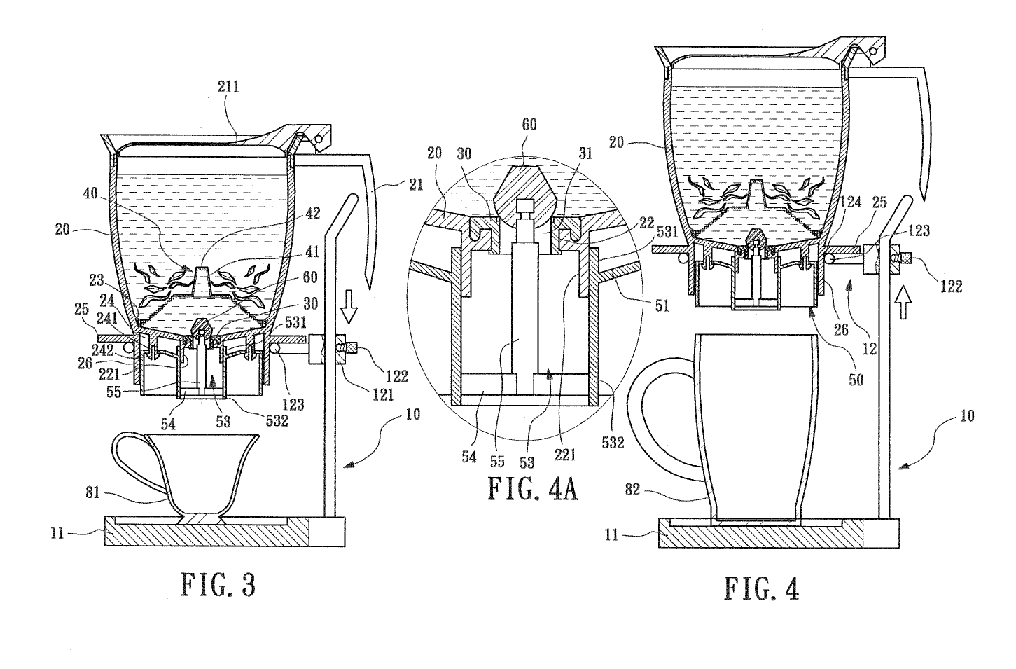

Referring to FIGS. 3 and 4, to use the present invention, the container 20 is placed on the retention device 12 of the support frame 10 with the positioning section 25 and the fitting section 26 securely supported on and in the frame 123 and the opening 124 to eliminate undesired gap or tolerance therebetween and allow the container 20 to be positioned stability and securely without being held by a hand to carry out a brewing operation at a desired altitude.

A user may tighten or loosen the locking member 122 to allow the retention device 12 to move vertically along the support frame 10 and then re-locked for adjusting the vertical distance between a lower end of the container 20 and the platform 11 and thus allowing cup 81, 82 of different sizes to be positioned between the lower end of the container 20 and the platform 11 for receiving brewed liquid dispensed from the container 20.

The user may deposits a brew substance in the container 20 and then pours in a liquid. Under this condition, the movable assembly 50 is located low and sets the valve 60 low to downward press against the opening 31 of the elastic member 30 (the bore 22) thereby blocking the opening 31 and preventing the brewed liquid from draining from the container 20, achieving an effect of blocking water and allowing a brewing operation to be carried out inside the container 20.

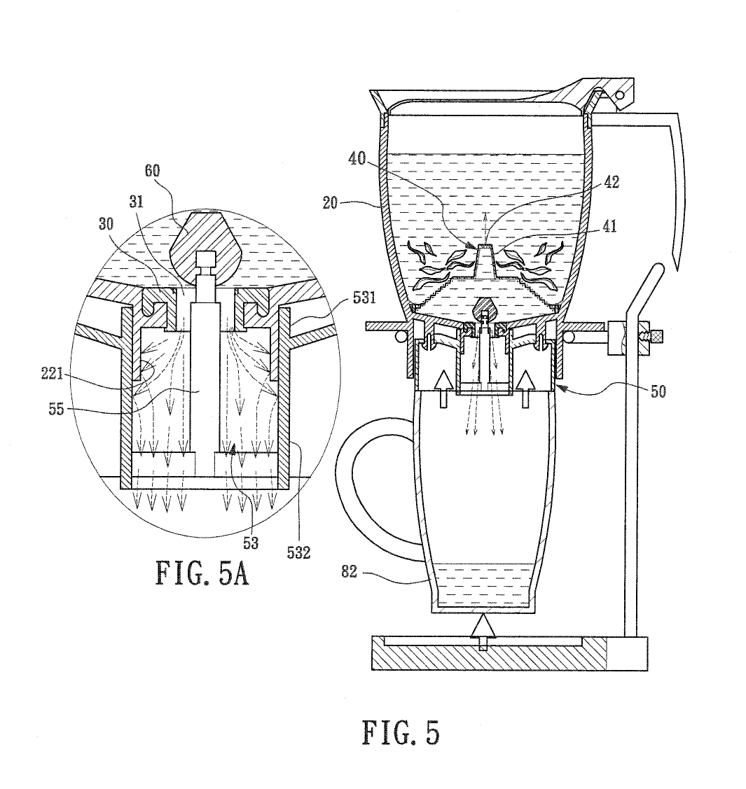

Referring to FIG. 5, after a predetermined time of brewing inside the container 20 elapses, the cup 82 may be raised to have a rim thereof engaging a lower side of the movable assembly 50, whereby with the upward push of the movable assembly 50 y the container 20, the movable assembly 50 is forced to move upward, causing the valve stem 55 to move the valve 60 away from the opening 31 of the elastic member 30. The brewed liquid inside the container 20 is thus allowed to flow through the opening 31, the guide section 221, and the water collection hole 53 to be received in the cup 82 for subsequent drinking.

When the opening 31 is discharging the brewed liquid, through aperture 42 of the filter 40 allows convection of air to improve smoothness of discharging of the brewed liquid. Further, the grip section 41 provides an easy way for hand holding, so that when the filter 40 breaks or requires cleaning, the filter 40 can be easily removed and/or re-mounted.

It is noted that when the brewed liquid dispensed from the container 20 is discharged through the opening 31, the multi-layered shielding structure constituted by the guide section 221, the joint section 531, and the water collection section 532 provides an effect of multiple shielding against outward diverging of the liquid flow and also helps prevent liquid leakage, whereby the water collection hole 53 may realize effective concentration and guidance of the liquid flow to prevent undesired leakage, splash, and spreading of the brewed liquid.

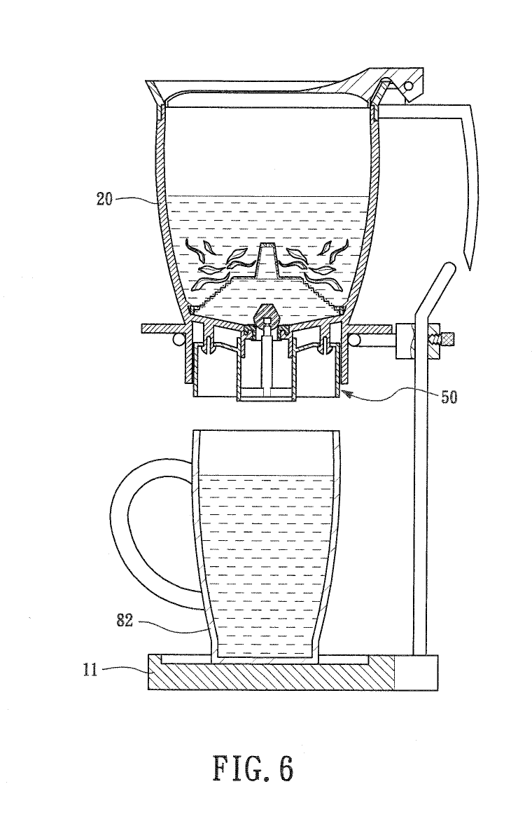

Referring to FIG. 6, the cup 82, when filled with the brewed liquid, can be positioned on the platform 11. Since the cup 82 is no longer in contact with the movable assembly 50, the container 20 may resume the operation of brewing.

Further, after the liquid has been drained from the container 20, even through little residue brewed liquid remains in the movable assembly 50, such liquid, which may be in the form of drops, can be received by the cup 82 so as not to stain the tabletop.

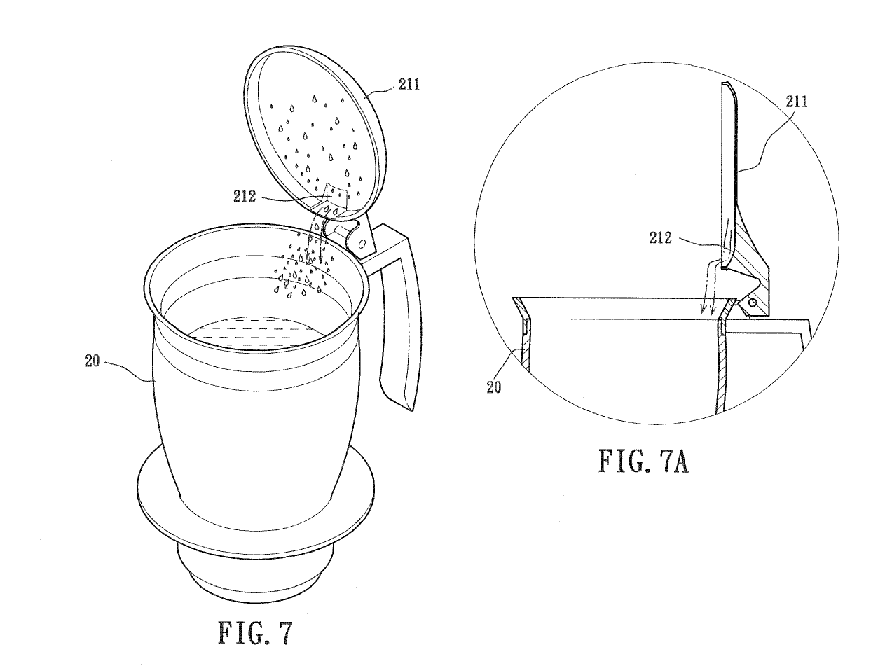

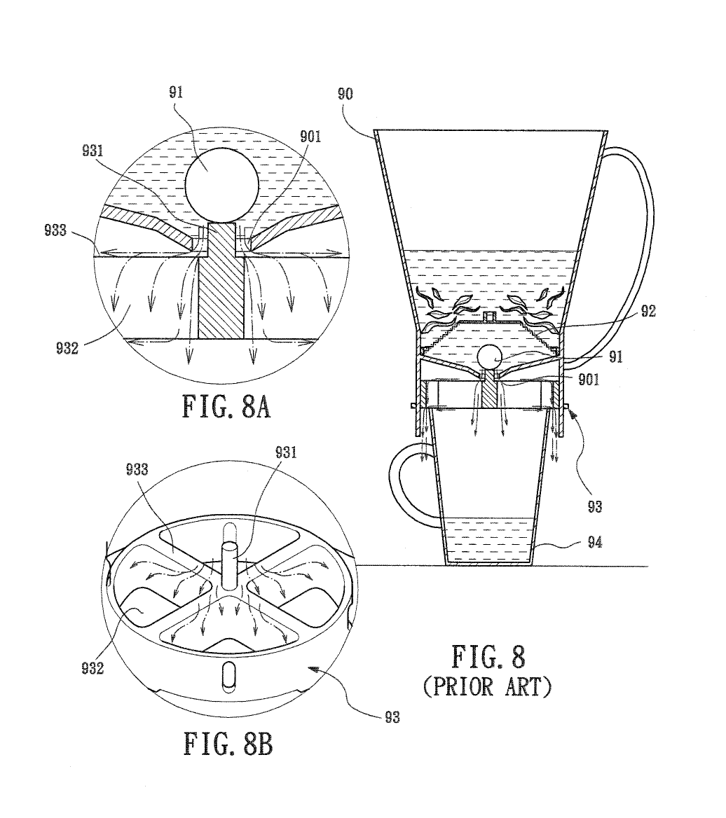

Referring to FIG. 7, according to the present invention, the lid 211 forms a recessed flow guide surface 212 adjacent to the opening of the container 20. Liquid drops that formed on the flow guide surface 212 of the lid 211 due to steam originating from the brewing inside the container 20, the flow guide surface 212 guide such liquid drops into the container 20 without splashing to the surface, making it sanitary.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A brewing structure featuring stability and water confinement, comprising:
a support frame, which comprises a retention device forming an opening; and
a container, which comprises a handle and a lid, the container having a bottom forming a bore, a guide section projecting down under a circumference of the bore, the bottom of the container forming a plurality of mounting pegs each having a diameter-expanded distal end, each of the mounting pegs forming at least one elastically deformable slot, the container forming on a side wall thereof a positioning section having an outside diameter greater than the opening, the container forming on the bottom thereof a fitting section having an outside diameter smaller than the opening;
a filter, which is received in the container; and
a movable assembly, which comprises a body forming at least three through holes corresponding to the mounting pegs, the distal ends of the mounting pegs being deformable to be received into the through holes so that the distal ends of the mounting pegs are coupled to the movable assembly in such a way to allow the movable assembly to be movable in a vertical direction, the body forming a water collection hole, the water collection hole comprising a valve stem mounted therein and received in the bore, whereby when the movable assembly moves upward, the valve stem pushes away a valve that is received in the bore, a joint section forming around the water collection hole and projecting upward beyond the body to joint the guide section, a water collection section projecting down beyond the body to form a water guide channel having a multi-layered shielding, water collection, and flow guidance structure.

2. The brewing structure according to claim 1, wherein the support frame forms at an upper end an inverted U-shaped that diverges outward.

3. The brewing structure according to claim 1, wherein the retention device is vertically movable through a movable seat slidably mounted to the support frame, the movable seat comprising a locking member extending therethrough to be selectively set in tight engagement with the support frame.

4. The brewing structure according to claim 1, wherein the bore receives therein an elastic member, the elastic member forming an opening, the valve selectively blocking the opening.

5. The brewing structure according to claim 1, wherein the container forms on an inside surface thereof a plurality of projections for engaging and retaining the filter.

6. The brewing structure according to claim 1, wherein the filter comprises a grip section through which a through aperture is formed.

7. The brewing structure according to claim 1, wherein the lid forms a recessed flow guide surface for guiding liquid drops into the container.
